(19) United States
(12) Patent Application Publication
(10) Pub. No.: US 2012/0141193 A1
(43) Pub. Date: Jun. 7, 2012

(54) Chain pin for connecting to a lifting chain of an industrial truck

(75) Inventors: Carsten Harnisch, Hamburg (DE); Dominik Plachta, Oersdorf (DE)

(73) Assignee: JUNGHEINRICH AKTIENGESELLSCHAFT, Hamburg (DE)

(21) Appl. No.: 13/310,155

(22) Filed: Dec. 2, 2011

(30) Foreign Application Priority Data
Dec. 3, 2010 (DE) 20 2010 016 166.5

(51) Int. Cl. F16B 1/00

(52) U.S. Cl. 403/224

(57) ABSTRACT

The invention relates to a chain pin that is for connecting to a lifting chain of an industrial truck and having a longitudinal extension and can be guided in the longitudinal direction through a boring in a fork carrier and/or lifting frame of the industrial truck, and having on its first end a head with an extension perpendicular to the longitudinal extension that is greater than the inner diameter of the boring, where an elastic bearing element is arranged on the side of the head distant from the first end and surrounds the chain pin and has a first section and a second section, where the first section has an extension perpendicular to the longitudinal extension of the chain pin that is greater than the inner diameter of the boring, and the second section is formed so that it can be inserted into the boring.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a chain pin for connecting to a lifting chain of an industrial truck.

The lifting frame, also termed the lifting mast, of industrial trucks is used to elevate the lifted load. The lifting frame is a major component of all industrial trucks with a lifting device. The lifting frame consists in principle of an external fixed mast in which a fork carrier moves to which the tines or other attachments are affixed. In most cases, one or more internal movable masts move in the fixed mast: Single or double telescopic lifting frames have one inner movable mast, and triple telescopic frames have two inner movable masts. Depending on the construction, the lifting frame has one or more lifting cylinders, one or more lifting chains, corresponding hydraulic lines and hydraulic connections.

The lifting chains are fixed to the fork carrier and lifting frame with the aid of chain pins. It is known to provide chain pins with an outer thread by means of which to fix their vertical position and hence the end positions of the fork carrier on the lifting frame at a given chain length. The chain pins are components subject to high stress and are key to safety. If this component fails, the load can fall, for example.

The chain pins are exclusively designed for tensile force. Given the shape and notch effect of the thread, the chain pins are very sensitive to transverse forces. Transverse forces can arise when the tensile force on the chain pin is not precisely parallel with the longitudinal axis of the chain pin. This can arise from an angled insertion of the chain pin due to manufacturing tolerances (the boring for example in the crossbar that receives the pin, uneven seat of the thread), geometric errors from the kinematics when extending the lifting frame, or geometric errors from the elastic deformation of the lifting frame under a load.

Geometric errors arising from kinematics can be prevented by a careful design, but this makes the construction more involved. Manufacturing tolerances as well as geometric errors from the deformation of the lifting frame are in contrast very difficult to avoid.

To compensate for angle errors, ball sockets are known, the structure of which will be discussed later in greater detail. This enables the change pin to be precisely aligned flush with the chain when lifting the load. Such ball sockets are therefore suitable for compensating angle errors in the listing process. If, due to imprecise kinematics or elastic deformation, additional angle errors arise when the load is lifted in a mast lift and free lift, significant lateral forces can arise despite the ball socket. The friction in the ball socket is so high under a load that the chain cannot execute the transverse movement, and its alignment does not adapt to the tension of the chain.

Another disadvantage of the known solution is that the position of the chain pin in its seat, for example in a boring of the crossbeam or in a chain pin seat welded to the mast profile, is undefined. When a ball socket is used, the pin can contact the side of the boring which shortens the life of the pin.

In addition, the chain pin can slip downward through the crossbeam since it is not secured in a vertical direction. This can for example occur when the fork lies on a hindrance, the lifting cylinder continues to move, and the chain is relaxed. This can damage the chain pin that has slipped through.

In DE 10 2008 051 139 A1, the entire contents of which is incorporated herein by reference, a device is disclosed for attaching a chain to an industrial truck. The device has a receiving part with a passage that has a narrow cross-section between its ends. The bottom end of a chain anchor is provided with a head and is arranged in the receiving part.

DE 80 23 051 U1, the entire contents of which is incorporated herein by reference, discloses a safety device for a chain in an order picker in which a chain pin is held under tension by means of a spring.

The underlying problem of the invention is to provide a chain pin by means of which the aforementioned disadvantages are overcome.

This problem is solved by a chain pin according to the invention.

### BRIEF SUMMARY OF THE INVENTION

The chain pin according to the invention to be connected with a lifting chain of an industrial truck has a longitudinal extension and can be guided in the longitudinal direction through a hole in a fork carrier and/or lifting frame of the industrial truck. In addition, the first end of the chain pin has a head, the extension of which perpendicular to the longitudinal extension being greater than an inner diameter of the boring. On the side of the head distant from the first end, an elastic bearing element is arranged that surrounds the chain pin and has a first section and a second section, where the first section has an extension perpendicular to longitudinal extension of the chain pin that is greater than the inner diameter of the boring, and the second section is shaped such that it can be inserted into the boring.

By means of the chain pin according to the invention, misalignment between the lifting chain and chain pin can be compensated. The elastic enduring element also allows the pin to be specifically guided and centered within the boring in which it can be inserted. This prevents the side of the pin from rubbing on the hole and reduces wear. The chain pin according to the invention allows the angle to be compensated over the entire lifting height since the friction forces arising from the tensile force plays a reduced role due to the elastic bearing element. The chain pin is also more economical to produce since concave milling in the area of the hole is not necessary. In addition, the chain pin can be friction locked in the hole due to the second section of the bearing element insertable into the boring. The sliding through of the pin and resulting damage is prevented.

The elastic bearing element is preferably annular, and the second section is formed by a step at which the bearing element has a reduced outer diameter. The single part shape of the bearing element allows assembly to be simplified. The first section and the second section of the bearing element can alternately be separately formed annular discs with different outer diameters that can simplify production.

The chain pin preferably has an outer thread. When the head and pin are separately formed, this allows conventional locknuts with an inner thread to be used and thereby allows the continuous adjustment of the vertical position of the chain pin in the boring.

In a preferred embodiment, the head is formed by a washer and at least one locknut. This increases the adaptability to borings of different sizes. During assembly, this also allows the chain pin to be inserted with the first end in front which increases the flexibility of the design of a second end of the chain pin, particularly in view of connecting to the lifting chain.

The second section of the bearing element preferably has a longitudinal extension that is at least as large as the longitudinal extension of the first section. The second section of the bearing element can also have a longitudinal extension that at least corresponds to one-half the length of the boring. In this manner, contact between the chain pin and the inner wall of the boring is even more effectively prevented.

The second end of the chain pin preferably has a holding element for connecting to a lifting chain of an industrial truck. This holding element can be formed as a single part with the chain pin which increases the stability of the connection, and an additional connecting component can be dispensed with.

### BRIEF DESCRIPTION OF THE SEVERAL VIEWS OF THE DRAWINGS

The invention is described in the following in more detail with reference to drawings.

FIG. 1 Shows a section of a state-of-the-art chain pin.

FIG. 2a: Shows a section of a chain pin according to the invention.

FIG. 2b: Shows a section of the chain pin according to FIG. 2a subject to transverse force.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

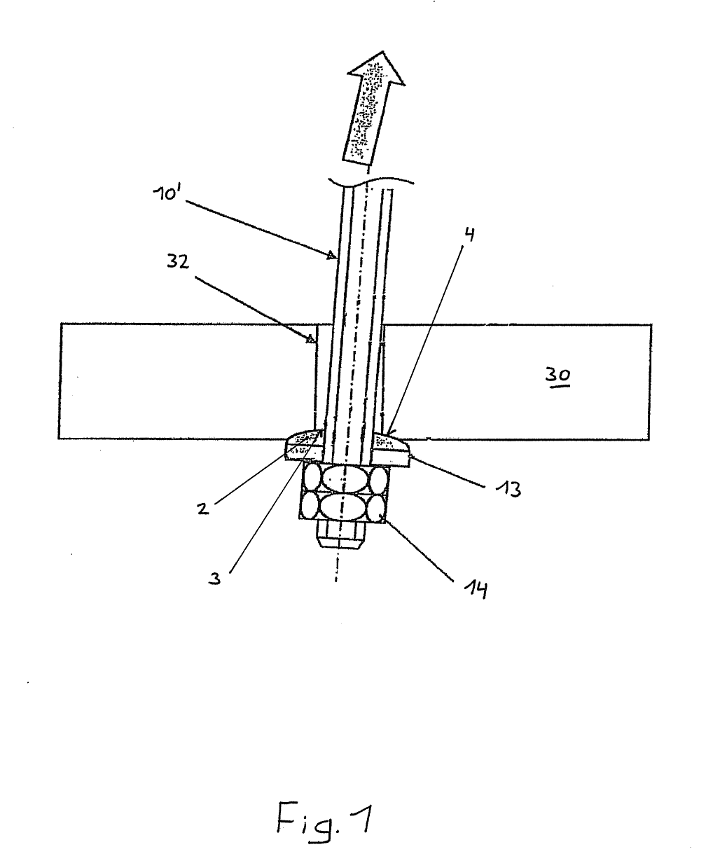

FIG. 1 shows a known chain pin 10. This extends through a boring 32 into a crossbeam 30. The crossbeam 30 can be a crossbeam of a fork carrier or a crossbeam of a lifting frame of an industrial truck. The chain pin 10 serves to hold a lifting chain (not shown), where one end of the lifting chain is conventionally fastened to the lifting frame, and the other end of the lifting chain is fastened to the fork carrier.

The known chain pin 10′ is, as mentioned above, in contact with the crossbeam 30 by means of a ball socket. Such a ball socket comprises at least one metal annular disk 2 that surrounds the chain pin 10′ and is held by a washer 13 and locknut 14. The annular disc 2, on its side facing the crossbeam 30, has a convex curvature 3 in the form of a spherical cap. To prevent strong surface pressure, the corresponding opposing surface 4 of the crossbeam 30 that contacts the convex annular disc 2 is designed concave. Low surface pressure is achieved when the concave opposing surface 4 is a semi-spherical ball socket resting against the spherical cap. The convex annular disc 2 and concave opposing surface 4 can then slide relative to each other, and this sliding causes the chain pin 10′ to tip relative to the crossbeam 30. Under a load, friction is very high in the ball socket between the annular disc 2 and opposing surface 4 so that the chain pin cannot always execute transverse movements, and its alignment cannot adapt to the traction of the chain. In addition, the chain pin 10′ can contact the inner wall of the boring 32 when angled too strongly, whereby the chain pin 10′ can become damaged.

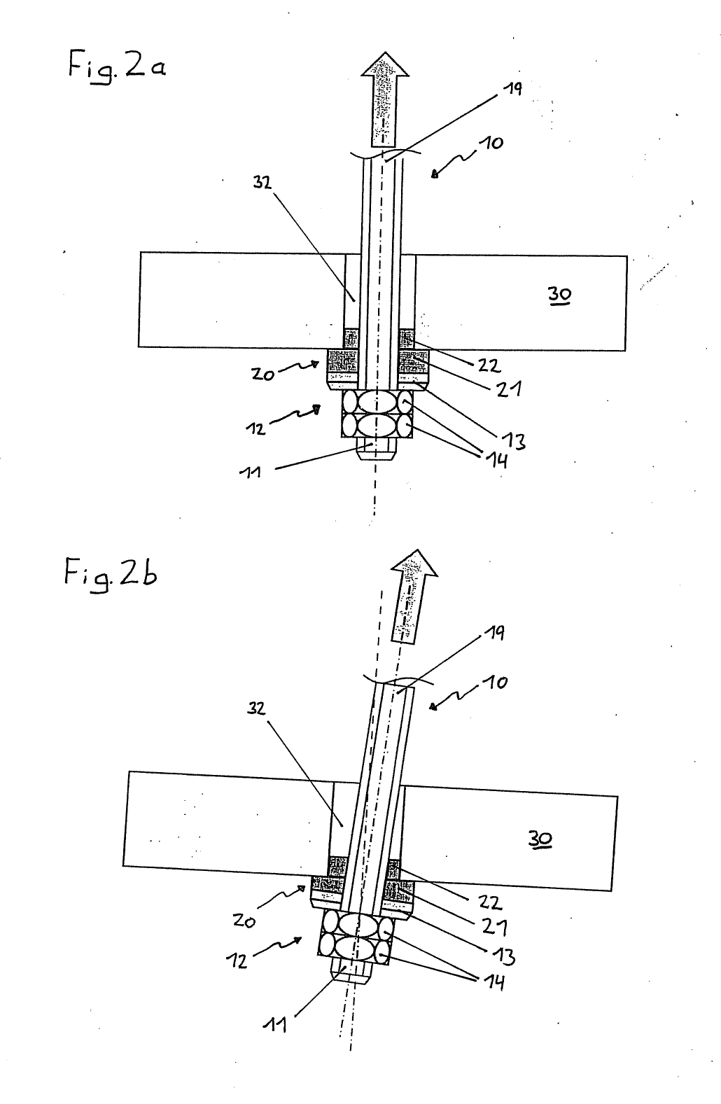

FIG. 2a shows a chain pin 10 according to the invention that extends like the known chain pin 10′ through the boring 32 of a crossbeam 30. On a first end 11 of the chain pin 10, a bottom end under normal circumstances and in the drawing as well, there are two locknuts 14 screwed onto the outer thread of the chain pin 10 (not shown) that, together with a washer 13, form a head 12 of the chain pin 10. On the side of the head 12 distant from the first end 11, i.e., above the washer 13, there is an annular, elastic bearing element 20. This surrounds the chain pin 10 and abuts the crossbeam 30 in the state in which it is inserted in the hole 32.

The elastic bearing element 20 has a first annular section 21, the inner diameter of which corresponds to the outer diameter of the chain pin 10, and the outer diameter of which is larger than the diameter of the boring 32 of the crossbeam 30. In addition, the elastic bearing element 20 has a second annular section 22, the inner diameter of which corresponds to the outer diameter of the chain pin 10, and the outer diameter of which corresponds to the diameter of the boring 32 of the crossbeam 30. The elastic bearing element 20 is preferably formed as a single part consisting of the first section 21 and second section 22, but it can alternately be formed of two separate annular discs that correspond to the first of section 21 and the second section 22. A peripheral step is formed by the first section 21 and second section 22 of the elastic bearing element 20, and abuts the crossbeam 30 or inner wall of the boring 32.

A top end 19 of the chain pin 10 transitions as a single part into a holding element (not shown) by means of which the chain pin 10 can be connected to a lifting chain of the industrial truck.

FIG. 2a shows a perpendicularly aligned chain pin 10, whereas FIG. 2b shows a chain pin 10 that is angled under transverse force. The elastic bearing element 20 in FIG. 2b is deformed corresponding to the angle and the second section 22 is also deformed, but contact between the change pin 10 and inner wall of the boring 32 is prevented. The exerted transverse force causes an elastic deformation of the bearing element 20. Friction forces between the head 12 of the chain pin 10 and crossbeam 30 do not have to be overcome to allow the chain pin 10 to angle.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A chain pin (10) that is for connecting to a lifting chain of an industrial truck and having a longitudinal extension and can be guided in the longitudinal direction through a boring (32) in a fork carrier and/or lifting frame of the industrial truck, and having on its first end (11) a head (12) with an extension perpendicular to the longitudinal extension that is greater than the inner diameter of the boring (32), characterized in that an elastic bearing element (20) is arranged on the side of the head (12) distant from the first end (11) and surrounds the chain pin (10) and has a first section (21) and a second section (22), where the first section (21) has an extension perpendicular to the longitudinal extension of the chain pin (10) that is greater than the inner diameter of the boring (32), and the second section (22) is formed so that it can be inserted into the boring (32).

2. The chain pin according to claim 1, characterized in that the elastic bearing element (20) is annular, and the second section (22) is formed by step at which the bearing element (20) has a reduced outer diameter.

3. The chain pin according to claim 1, characterized in that the chain pin (10) has an outer thread.

4. The chain pin according to claim 1, characterized in that the head (12) is formed by a washer (13) and at least one locknut (14).

5. The chain pin according to claim 1, characterized in that the second section (22) of the bearing element (20) has a longitudinal extension that is at least as large as the longitudinal extension of the first section (21).

6. The chain pin according to claim 1, characterized in that the second section (22) of the bearing element (20) has a longitudinal extension that at least corresponds to one-half the length of the boring (32).

7. The chain pin according to claim 1, characterized in that the chain pin (10) has a holding element on a second end (19) for connecting to a lifting chain of an industrial truck.
